(19) United States
(12) Patent Application Publication
(10) Pub. No.: US 2006/0092537 A1
(43) Pub. Date: May 4, 2006

(54) Magnetic transfer apparatus, method of operating the same and magnetic recording medium

(75) Inventors: Hisashi Tsubata, Odawara-shi (JP); Minoru Araki, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/260,383

(22) Filed: Oct. 28, 2005

(30) Foreign Application Priority Data
Oct. 29, 2004 (JP) 2004-316851
Oct. 29, 2004 (JP) 2004-316854

(51) Int. Cl. G11B 5/86

(52) U.S. Cl. 360/17

(57) ABSTRACT

According to a method and an apparatus of the present invention, it is possible to remove a slave disk remaining within the apparatus to outside the apparatus while efficiently suppressing the pollution of the master disk and a decrease in the working rate during the occurrence of an abnormality in the apparatus. Also, according to a method and an apparatus of the present invention, it is possible to ensure sufficient cleanness during troubles such as breakdowns of the apparatus and even when adjustment work is necessary and to dramatically improve the life of a master disk.

### BACKGROUND OF THE INVENTION

1. Field of the Invention

The present invention relates to a magnetic transfer apparatus, a method of operating the magnetic transfer apparatus and a magnetic recording medium and, more particularly, to a magnetic transfer apparatus which transfers magnetic information patterns, such as format information, to a magnetic disk used in a hard desk device etc. from a master disk, an operation method during operation abnormalities of the magnetic transfer apparatus, and a magnetic recording medium manufactured by use of the operation method.

2. Description of the Related Art

In a magnetic disk (a hard disk) which is used in a hard disk drive which has rapidly come into wide use in recent years, it is general practice that format information and address information are written before the magnetic disk (the hard disk) is incorporated into the drive after delivery from a magnetic disk maker to a drive maker. Although this writing can also be performed by use of a magnetic head, it is efficient and desirable to perform collective transfer from a master disk in which these format information and address information are written.

For magnetic transfer apparatus of this kind, various proposals have hitherto been made (refer to the Japanese Patent Application Laid-Open No. 63-183623, the Japanese Patent Application Laid-Open No. 10-40544 and the Japanese Patent Application Laid-Open No. 10-269566, for example). Among these, the proposal of the Japanese Patent Application Laid-Open No. 63-183623 is made to the effect that the work efficiency of magnetic transfer of a flexible disk (what is called a floppy disk) is improved. The proposal of the Japanese Patent Application Laid-Open No. 10-40544 is made to the effect that concavities and convexities corresponding to information signals are formed on a surface of a master disk and the productivity and the like during magnetic transfer are thereby improved. The proposal of the Japanese Patent Application Laid-Open No. 10-269566 is made to the effect that a large number of through holes are provided in a master disk and the adhesion to a magnetic disk (a slave disk) is improved, whereby the reliability of magnetic transfer is improved.

In this magnetic transfer apparatus, particulates, dusts and the like cause flaws on surfaces of a master disk if the cleanness within the apparatus is low. Therefore, the master disk is housed within a cover and cleanliness is satisfactorily maintained.

However, during the occurrence of an abnormality in the magnetic transfer apparatus, for example, in the case of an abnormality such as poor holding of a slave disk and poor positioning of a slave disk in which there is no choice other than to stop the operation of the magnetic transfer apparatus due to troubles on the downstream side, it is necessary to remove the slave disk remaining within the magnetic transfer apparatus to outside the apparatus. For this purpose, it has been conventional practice to remove a slave disk remaining within the apparatus by manually opening a cover or to discharge all slave disks remaining within the apparatus to outside the apparatus by causing the slave disks to flow to the discharge side.

For magnetic transfer techniques of this kind, various proposals have been made (refer to the Japanese Patent Application Laid-Open No. 2001-250227, the Japanese Patent Application Laid-Open No. 2001-351232 and the Japanese Patent Application Laid-Open No. 2001-351234, for example). Among these, the proposal of the Japanese Patent Application Laid-Open No. 2001-250227 is made to the effect that the work efficiency is improved by the intermittent driving of one handler during magnetic transfer.

The proposal of the Japanese Patent Application Laid-Open No. 2001-351232 is made to the effect that positioning accuracy is improved by introducing image recognition in the positioning of a master disk and a hard disk to which transfer is performed (a slave disk) when magnetic transfer is performed. The proposal of the Japanese Patent Application Laid-Open No. 2001-351234 is made to the effect that the life of a master disk is improved by improving the cleanness during magnetic transfer.

However, in magnetic transfer apparatus as proposed in the Japanese Patent Application Laid-Open No. 63-183623, the Japanese Patent Application Laid-Open No. 10-40544 and the Japanese Patent Application Laid-Open No. 10-269566, the method which involves manually removing a slave disk by opening a cover has the problem that the cleanness within the apparatus worsens, with the result that not only there is a danger that a master disk is polluted, but also an idle operation to recover the interior of the cover to the original cleanness must be performed for 1 hour or more when the cover is closed and operation is restarted, leading to a decrease in the working rate.

Also, in the method which involves causing all slave disks remaining within the apparatus to flow to the discharge side, even a slave disk before magnetic transfer present in the disk supply line must be brought into close contact with a master disk in the process of discharging the slave disks, thereby increasing the degree of risk of polluting the master disk.

Furthermore, in conventional techniques as disclosed in the Japanese Patent Application Laid-Open No. 2001-250227, the Japanese Patent Application Laid-Open No. 2001-351232 and the Japanese Patent Application Laid-Open No. 2001-351234, the problem that the life of a master disk is short and, therefore, a master disk must be frequently replaced has been pointed out. That is, when magnetic transfer is performed, it is necessary that a master disk and a hard disk to which transfer is performed (a slave disk) be brought into close contact with each other and if the cleanness in this environment is low, particulates, dusts and the like often cause flaws on surfaces of the master disk.

For this reason, also conventional magnetic transfer apparatus are often installed within a booth having good cleanness and it has also been proposed to devise a method of preventing clean air from stagnating as in the Japanese Patent Application Laid-Open No. 2001-351234.

### SUMMARY OF THE INVENTION

However, even when the apparatus is installed within a booth having good cleanness and magnetic transfer is performed within this booth, a cover, door, etc. of the clean booth are often opened due to troubles such as breakdowns of the apparatus and because of the necessity of adjustment work. In such cases, even when the time is short, the outside air (the air in the room) having low cleanness may sometimes flow into the clean booth. In such cases, particulates, dusts and the like adhere to surfaces of the master disk and cause flaws on the surfaces of the master disk during transfer.

The present invention has been made in view of such circumstances and has as its object the provision of a magnetic transfer apparatus which can remove a slave disk (a slave disk) remaining within the apparatus to outside the apparatus while efficiently suppressing the pollution of a master disk and a decrease in the working rate during the occurrence of an abnormality in the apparatus and a method of operating the apparatus.

Also, the present invention has as its object the provision of a magnetic transfer apparatus which can ensure sufficient cleanness during troubles such as breakdowns of the apparatus and even when adjustment work is necessary and which can dramatically improve the life of a master disk.

To achieve the above-described objects, a first aspect of the present invention provides a method of operating a magnetic transfer apparatus for magnetically transferring a specific magnetic information pattern formed in a master disk to a slave disk, wherein during the occurrence of an abnormality in the magnetic transfer apparatus, the slave disk present within the magnetic transfer apparatus is automatically discharged to outside the apparatus without being brought into contact with the master disk.

According to the first aspect, because during the occurrence of an abnormality in the magnetic transfer apparatus, the slave disk present within the magnetic transfer apparatus is automatically discharged to outside the apparatus without being brought into contact with the master disk, the degree of risk of polluting the master disk is reduced. At the same time, because it is unnecessary to open the cover of the apparatus, the worsening of the cleanness within the apparatus does not occur, the operation can be restarted immediately after the recovery from an abnormality in the apparatus and the working rate does not decrease.

To achieve the above-described objects, a second aspect of the present invention provides a method of operating a magnetic transfer apparatus including a disk supply line which supplies a slave disk to a holder portion which holds a master disk having a specific magnetic information pattern, a magnetic transfer line which transfers the magnetic information pattern of the master disk by applying a transfer magnetic field after bringing the slave disk into close contact with the master disk held in the holder portion, and a disk discharge line which discharges the slave disk after magnetic transfer, which are arranged in sequence from the upstream to downstream side of the apparatus. In this operating method, during the occurrence of an abnormality in the magnetic transfer apparatus, a slave disk present in or behind the magnetic transfer line is conveyed to the downstream side and discharged to outside the apparatus via the disk discharge line, whereas a slave disk present in the disk supply line is returned to the upstream side by reverse conveyance control of the disk supply line and discharged to outside the apparatus.

According to the second aspect, during the occurrence of an abnormality in the magnetic transfer apparatus, a slave disk present in or behind the magnetic transfer line is conveyed to the downstream side and discharged to outside the apparatus via the disk discharge line, whereas a slave disk present in the disk supply line is returned to the upstream side by reverse conveyance control of the disk supply line and discharged to outside the apparatus. As a result of this, because a slave disk present in the disk supply line is returned to the upstream side and can be discharged to outside the apparatus without being brought into close contact with the master disk, the degree of risk of polluting the master disk is reduced. Also, because it is unnecessary to open the cover of the apparatus, the worsening of the cleanness within the apparatus does not occur, the operation can be restarted immediately after the recovery from an abnormality in the apparatus and the working rate does not decrease.

The feature of a third aspect is that in the second aspect, a slave disk which has been returned to the upstream side via the disk supply line is discharged to outside the apparatus from a discharge outlet intended for use only during an abnormality.

By discharging a slave disk present in the disk supply line during the occurrence of an abnormality to outside the apparatus from a discharge outlet intended for use only during an abnormality, it is possible to clearly discern that this is a slave disk during an abnormality.

To achieve the above-described objects, a fourth aspect of the present invention provides a method of operating a magnetic transfer apparatus including a disk supply line which supplies a slave disk to a holder portion which holds a master disk having a specific magnetic information pattern, a magnetic transfer line which transfers the magnetic information pattern of the master disk by applying a transfer magnetic field after bringing the slave disk into close contact with the master disk held in the holder portion, and a disk discharge line which discharges the slave disk after magnetic transfer, which are arranged in sequence from the upstream to downstream side of the apparatus. In this operating method, during the occurrence of an abnormality in the magnetic transfer apparatus, a slave disk present in or behind the magnetic transfer line is conveyed to the downstream side and discharged to outside the apparatus via the disk discharge line, whereas a slave disk present in the disk supply line is discharged to outside the apparatus via a conveyance device to work during an abnormality which conveys a disk to the disk discharge line without passing through the holder portion.

According to the fourth aspect, during the occurrence of an abnormality in the magnetic transfer apparatus, a slave disk present in or behind the magnetic transfer line is sent to the downstream side via the disk discharge line and discharged to outside the apparatus. On the other hand, a slave disk present in the disk supply line is discharged to outside the apparatus by use of a conveyance device to work during an abnormality which conveys a disk to the disk discharge line without using the holder portion. As a result of this, because the slave disk present within the magnetic transfer apparatus can be discharged to outside the apparatus without being brought into close contact with the master disk, the degree of risk of polluting the master disk is reduced. Also, because it is unnecessary to open the cover of the apparatus, the worsening of the cleanness within the apparatus does not occur, the operation can be restarted immediately after the recovery from an abnormality in the apparatus and the working rate does not decrease.

The feature of a fifth aspect of the present invention is that in the fourth aspect, the conveyance device to work during an abnormality is a holder portion intended for use only during an abnormality, which is provided in the magnetic transfer line separately from the holder portion.

Because a holder portion intended for use only during an abnormality is provided in the magnetic transfer line separately from the holder portion to hold a master disk and because during the occurrence of an abnormality, a slave disk present in the disk supply line is conveyed to the disk discharge line by use of a holder portion intended for use only during an abnormality, the degree of risk of polluting the master disk is reduced. Also, because the conveyance mechanism of the holder portion can be used as it is in the holder portion intended for use only during an abnormality, the apparatus does not increase in size.

To achieve the above-described objects, a sixth aspect of the present invention provides a magnetic transfer apparatus for magnetically transferring a specific magnetic information pattern formed in a master disk to a slave disk. The magnetic transfer apparatus comprises a mechanism which automatically discharges a slave disk present within the magnetic transfer apparatus to outside the apparatus without bringing the slave disk into contact with the master disk.

According to the magnetic transfer apparatus of the sixth aspect, because there is provided a mechanism which automatically discharges a slave disk present within the magnetic transfer apparatus without bringing the slave disk into contact with the master disk, during the occurrence of an abnormality in the magnetic transfer apparatus, a slave disk present in the magnetic transfer apparatus can be automatically discharged to outside the apparatus without being brought into contact with the master disk. Therefore, the degree of risk of polluting the master disk is reduced. At the same time, because it is unnecessary to open the cover of the apparatus, the worsening of the cleanness within the apparatus does not occur, the operation can be restarted immediately after the recovery from an abnormality in the apparatus and the working rate does not decrease.

To achieve the above-described objects, a seventh aspect of the present invention provides a magnetic transfer apparatus including a disk supply line which supplies a slave disk to a holder portion which holds a master disk having a specific magnetic information pattern, a magnetic transfer line which transfers the magnetic information pattern of the master disk to the holder portion by applying a transfer magnetic field after bringing the slave disk into close contact with the master disk held in the holder portion, and a disk discharge line which discharges the slave disk after magnetic transfer, which are arranged in sequence from the upstream to downstream side of the apparatus, the magnetic transfer apparatus comprising: a mechanism which can select the conveyance direction of the slave disk in the disk supply line from normal and reverse directions; and a control device which controls the operation of the magnetic transfer apparatus performs a shift to a control mode to work during an abnormality in which, during the occurrence of an abnormality in the magnetic transfer apparatus, a slave disk present in or behind the disk supply line is conveyed in the normal direction to the downstream side and a slave disk present in the disk supply line is conveyed in the reverse direction to the upstream side.

The magnetic transfer apparatus of the seventh aspect is constituted as an apparatus for carrying out the method related to the second aspect, and the apparatus comprises a mechanism which can select the conveyance direction of the slave disk in the disk supply line from normal and reverse directions. And in a control device which controls the operation of the magnetic transfer apparatus, there is incorporated a program for a control mode to work during an abnormality in which, during the occurrence of an abnormality in the magnetic transfer apparatus, a slave disk present in or behind the disk supply line is conveyed in the normal direction to the downstream side and an index table in the disk supply line is conveyed in the reverse direction to the upstream side. As a result of this, because a slave disk present in the disk supply line is returned to the upstream side and is not brought into close contact with the master disk, the degree of risk of polluting the master disk is reduced. And because it is unnecessary to open the cover of the apparatus, the worsening of the cleanness within the apparatus does not occur, the operation can be restarted immediately after the recovery from an abnormality in the apparatus and the working rate does not decrease.

To achieve the above-described objects, an eighth aspect of the present invention provides a magnetic transfer apparatus including a disk supply line which supplies a slave disk to a holder portion which holds a master disk having a specific magnetic information pattern, a magnetic transfer line which transfers the magnetic information pattern of the master disk to the holder portion by applying a transfer magnetic field after bringing the slave disk into close contact with the master disk held in the holder portion, and a disk discharge line which discharges the slave disk after magnetic transfer, which are arranged in sequence from the upstream to downstream side of the apparatus, wherein the holder portion is arranged in multiple numbers at prescribed intervals in the circumferential direction, and the apparatus comprises: an index table which sequentially feeds the holder portion to each operating position corresponding to each index position by intermittent rotations and a holder portion intended for use only during an abnormality which is arranged between the multiple holder portions and is intermittently rotated by the rotation of the index table and receives a slave disk present in the disk supply line in place of the holder portion during the occurrence of an abnormality in the magnetic transfer apparatus.

The magnetic transfer apparatus of the eighth aspect is constituted as an apparatus for carrying out the method related to the fourth aspect, and between the multiple holder portions provided in the index table, there is provided a holder portion intended for use only during an abnormality which receives a slave disk present in the disk supply line in place of the holder portion during the occurrence of an abnormality in the magnetic transfer apparatus. As a result of this, because the slave disk present within the disk supply line can be discharged to outside the apparatus without being brought into close contact with the master disk, the degree of risk of polluting the master disk is reduced. Also, because it is unnecessary to open the cover of the apparatus, the worsening of the cleanness within the apparatus does not occur, the operation can be restarted immediately after the recovery from an abnormality in the apparatus and the working rate does not decrease.

The feature of a ninth aspect of the present invention is that in any one of the sixth to eighth aspects, a drive part of the magnetic transfer apparatus is disposed below a conveyance height at which the slave disk is conveyed.

Because a drive part of the magnetic transfer apparatus is disposed below a conveyance height at which the slave disk is conveyed, dusts and the like generated from the drive part fall down and a slave disk becomes less apt to be polluted.

The feature of a magnetic recording medium in a tenth aspect of the present invention is that it is manufactured by the method of operating a magnetic transfer apparatus in any one of the first to fifth aspects.

By carrying out the method of operating a magnetic transfer apparatus in any one of the first to fifth aspects, the degree of risk of polluting the master disk is reduced even when an abnormality in the magnetic transfer apparatus occurs. Therefore, it is possible to perform good magnetic transfer from the master disk to a slave disk and a good magnetic recording medium can be manufactured.

To achieve the above-described objects, an eleventh aspect of the present invention provides a magnetic transfer apparatus comprising: a clean unit having an opening capable of being opened and closed by use of an opening door; a disk holding device which holds a pair of master disks each having a magnetic pattern by use of a pair of holder portions disposed in the interior of the clean unit; a supply device which supplies a slave disk between the pair of master disks held by the pair of holder portions in the interior of the clean unit; a drive device which actuates the holding device and causes the master disks to be pressed against both surfaces of the slave disk; a magnetic field application device which applies a magnetic field to the pair of holder portions in the interior of the clean unit and causes the magnetic pattern of the pair of master disks to be transferred to both sides of the slave disk; a hermetically sealing device which brings the pair of holders into close contact with each other and thereby causes a hermetically sealed space to be formed in the interior of the pair of holder portions; and an interlock device which actuates the hermetically sealing device before the interior of the clean unit is exposed to a normal atmosphere by opening the opening door and thereby causes a hermetically sealed space to be formed in the interior of the pair of holder portions.

According to the eleventh aspect of the present invention, there is provided a hermetically sealing device which causes a hermetically sealed space to be formed in the interior of the pair of holder portions, and there is also provided an interlock device which actuates the hermetically sealing device before the interior of the clean unit is exposed to a normal atmosphere by opening the opening door and thereby causes a hermetically sealed space to be formed in the interior of the pair of holder portions. Therefore, sufficient cleanness is ensured during troubles such as breakdowns of the apparatus and even when adjustment work is necessary and the life of a master disk can be dramatically improved.

Incidentally, “a hermetically sealed space” means an inner space for which the air flow with the outside is shut off and this means that polluted outside air (of low cleanness) does not enter the space.

Also, “a normal atmosphere” means a general room atmosphere in environments other than an environment in which cleanness is especially controlled, such as a clean room.

In the eleventh aspect, it is preferred that the holding positions of the master disks in the holder portions be set so that the contact of the master disks with each other is avoided when the hermetically sealing device is actuated. If the contact of the master disks with each other is avoided in this manner, combined with the ensuring of cleanness, the occurrence of flaws in the master disks can be prevented and the effects of the present invention can be further exhibited.

Furthermore, in the eleventh aspect, it is preferred that an air filter be provided in an upper part of the clean unit so that clean air having a cleanness class of not more than 3 can be supplied to peripheral edges of the pair of holder portions, that an air curtain device be provided in a place which is the upper part of the clean unit and the inside of the opening, and that there be provided an interlock device which actuates the air curtain device before the interior of the clean unit is exposed to a normal atmosphere by opening the opening door and thereby causes an air curtain to be formed on the inside of the opening.

If an air filter is provided like this so that clean air can be supplied to peripheral edges of the holder portions, and if an air curtain device is provided on the inside of the opening and an air curtain is caused to be formed before the opening of the opening door, the inflow of air of low cleanness from the outside can be suppressed and the effects of the present invention can be further exhibited.

Incidentally, “an air filter” means a HEPA filter, an ULPA filter, etc.

In the eleventh aspect, it is preferred that an air filter be provided in an upper part of the clean unit so that clean air having a cleanness class of not more than 3 can be supplied to peripheral edges of the pair of holder portions and the flow rate of the clean air can be changed by not less than two stages, and that there be provided an interlock device which increases the flow rate of the clean air supplied from the air filter before the interior of the clean unit is exposed to a normal atmosphere by opening the opening door.

If an air filter is provided like this and clean air is supplied to peripheral edges of the holder portions and if the flow rate of the clean air can be increased before the opening of the opening door, the inflow of air of low cleanness from the outside can be suppressed and the effects of the present invention can be further exhibited.

Also, in the eleventh aspect, it is preferred that the interlock device be capable of being released in a forced manner. If the interlock device can be released in a forced manner like this, this is convenient during maintenance work etc.

Furthermore, in the eleventh aspect, it is preferred that there be provided a judgment device which makes it known to workers whether the hermetically sealing device has been actuated. If it can be easily discerned like this whether the hermetically sealing device has been actuated, it becomes easy for workers to prevent wrong actions. It is possible to adopt as this judgment device, various publicly known devices, such as display lamps (patrol lights), control panel displays and alarm sounds.

In the eleventh aspect, it is preferred that there be provided an alarm device which makes it known to workers that the opening door has been opened and that the hermetically sealing device is not actuated. If an alarm is given like this when there is a high possibility that the master disk is polluted, this is convenient for workers. It is possible to adopt as this alarm, various publicly known devices, such as display lamps (patrol lights), control panel displays and alarm sounds.

As described above, according to the present invention, it is possible to remove a slave disk remaining within the apparatus to outside the apparatus while efficiently suppressing the pollution of the master disk and a decrease in the working rate during the occurrence of an abnormality in the apparatus.

Also, according to the present invention, it is possible to ensure sufficient cleanness during troubles such as breakdowns of the apparatus and even when adjustment work is necessary and to dramatically improve the life of a master disk.

### BRIEF DESCRIPTION OF THE DRAWINGS

FIG. 1 is a perspective view of a magnetic transfer apparatus related to the first and second embodiments of the present invention, part of the magnetic transfer apparatus is shown in a broken state;

FIG. 2 is a perspective view which shows how a slave disk is loaded and unloaded into and out of a cassette for disk;

FIGS. 3A and 3B are sectional views which show the construction of a holder unit;

FIG. 4 is a diagram of the disk supply line of FIG. 1 in another aspect in which two supply robots and a relay cassette are arranged and, at the same time, an explanatory diagram to explain a conventional flow until a slave disk is discharged to outside the apparatus during the occurrence of an abnormality in the apparatus;

FIG. 5 is a perspective view which shows how a master disk and a slave disk are positioned;

FIG. 6 is a conceptual diagram in which a drive part of the apparatus is disposed below a conveyance line of a slave disk;

FIG. 7 is an explanatory diagram to explain a flow until a slave disk is discharged to outside the apparatus in an operating method of the present invention during the occurrence of an abnormality in the apparatus;

FIG. 8 is a diagram of steps of programs for a normality mode and an abnormality mode in the operating method of the present invention;

FIG. 9 is a conceptual diagram to explain a magnetic transfer apparatus in the second embodiment of the present invention; and

FIG. 10 is a perspective view of the construction of a clean unit.

### DETAILED DESCRIPTION OF THE PREFERRED EMBODIMENTS

Preferred embodiments of a magnetic transfer apparatus related to the present invention and a method of operating the magnetic transfer apparatus will be described below with reference the accompanying drawings.

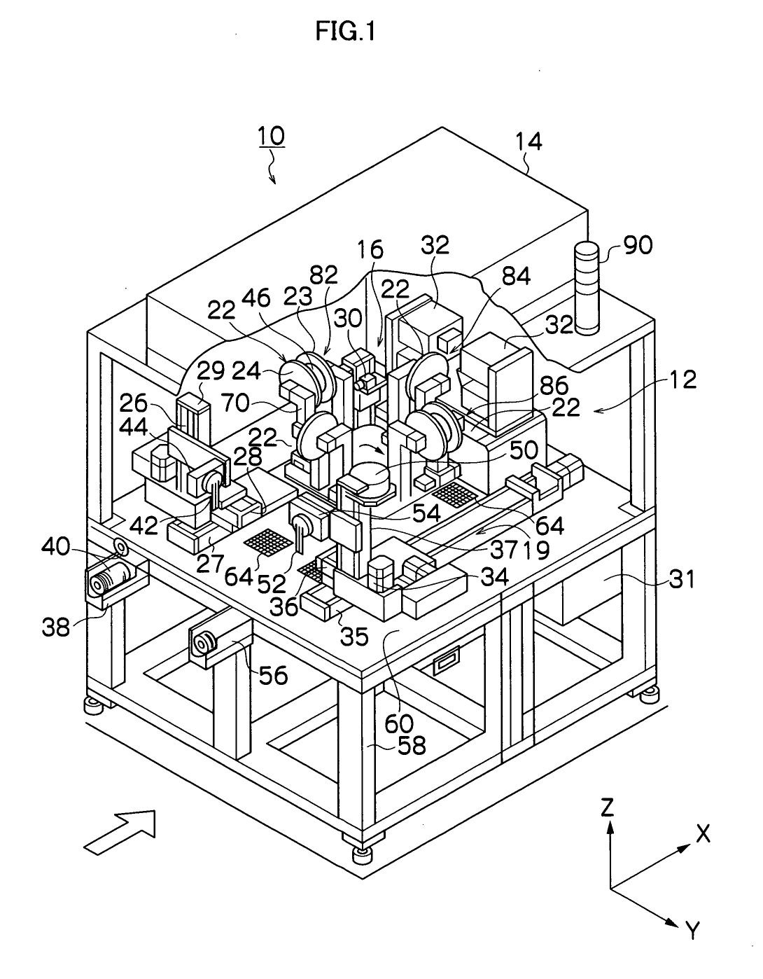

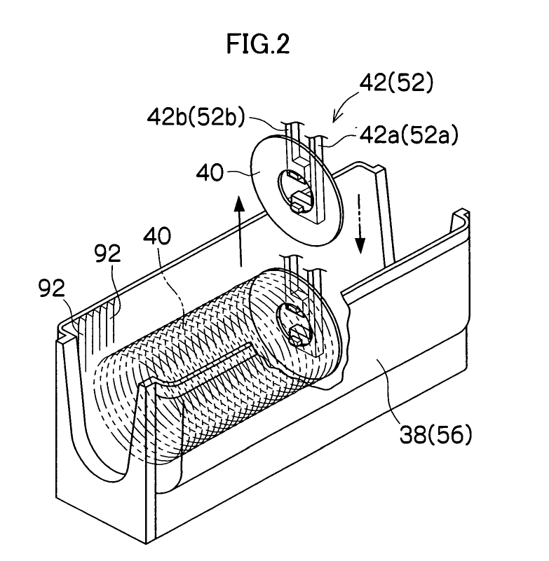

FIG. 1 is a perspective view which shows the general construction of a magnetic transfer apparatus 10 in the first embodiment of the present invention, and FIG. 2 is a perspective view which shows an outline of a cassette for disk. This magnetic transfer apparatus 10 is constituted by an apparatus main body 12 and a clean unit 14 which covers the whole of this apparatus main body 12. First, the general construction of this apparatus 12 will be described.

The apparatus main body 12 is provided with a frame 58, and a base 60 which forms a surface in the horizontal direction is provided on this frame 58. This apparatus main body 12 is enclosed, at the periphery thereof, by the clean unit 14 so that cleanness is ensured. Incidentally, the side indicated by a bold arrow in FIG. 1 is the front surface of the apparatus main body 12 and the opening side of the clean unit 14.

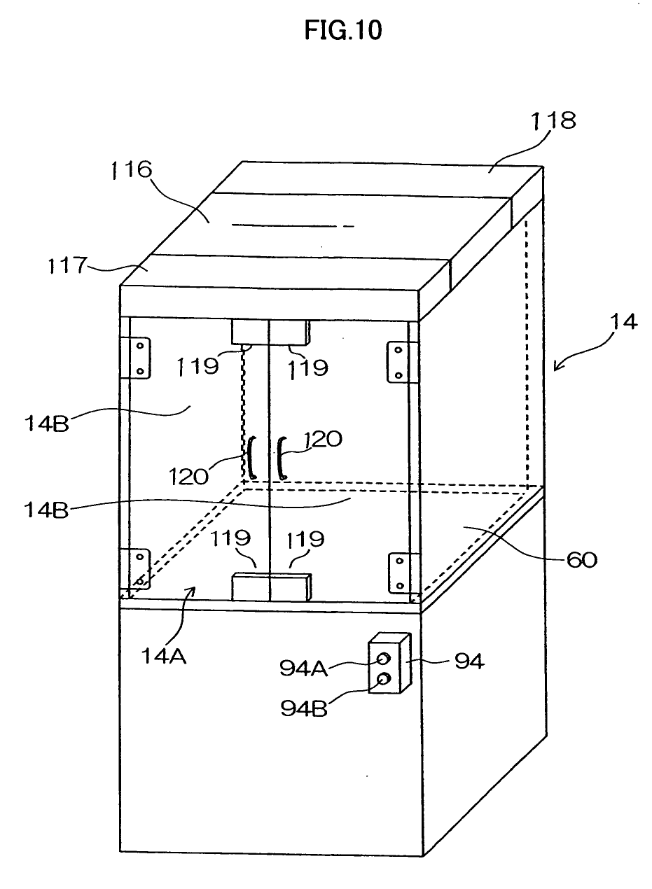

A clean air blowing unit 116 (refer to FIG. 10) which supplies clean air to the interior of the apparatus is provided in a ceiling portion of the clean unit 14. This clean air blowing unit 116 is constituted by an air filter, such as a HEPA filter and an ULPA filter, and a blowing fan so that clean air having cleanness of less than 100 by downflow can be supplied to the interior of the apparatus.

Clean air blown out by the clean air blowing unit is discharged to outside. For this reason, as shown in FIG. 1, on the base 60, there are disposed multiple exhaust fans 64 as exhaust devices in open areas where each mechanism of the apparatus main proper 12 is not arranged.

In the front end portion of the base 60, there are provided a supply cassette 38 which houses a slave disk 40, which is a slave disk, and a discharge cassette 56 as a cassette which recovers a slave disk 40 on which magnetic information has been transferred and which has been discharged. The supply cassette 38 and the discharge cassette 56 which are adopted have the same size.

As shown in FIG. 2, the supply cassette 38 and the discharge cassette 56 can house multiple slave disks 40, with the surfaces formed by them opposed to each other. That is, multiple grooves 92, 92 . . . are formed parallel in the inner surface of the cassette, and one slave disk 40 can be loosely fitted into each of the grooves 92, 92 . . . . The peripheries of the slave disks are held by surfaces formed by the grooves 92, and each of the multiple slave disks 40 is spaced from each other.

Next, a magnetic transfer line 16 will be described. As shown in FIG. 1, in a substantially middle portion of the top surface of the base 60, an index table 50 is mounted so as to be capable of being rotated by a shaft perpendicular to the base 60. On the index table 50, four holder units 22 as holding devices each of which holds a pair of master disks and one slave disk 40 are disposed at equal intervals (every 90 degrees).

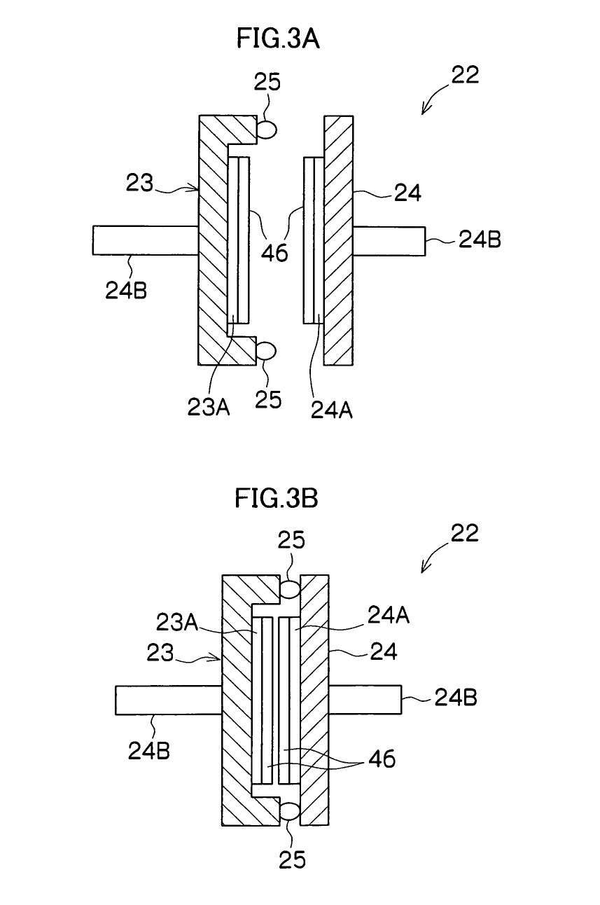

As shown in the sectional views of FIGS. 3A and 3B, the holder unit 22 is constituted by a fixed side holder 23 and a moving side holder 24, which form a pair of holder portions. The fixed side holder 23 and the moving side holder 24 each position, fix and hold the master disks 46 by adsorption or adhesion as off-line setups etc. At the same time, the fixed side holder 23 and the moving side holder 24 can each cause the master disks 46, 46 to support the slave disk 40 by sandwiching the slave disk 40 in a condition of close contact.

The fixed side holder 23 and the moving side holder 24 fix the master disks 46, 46 having different recorded information to each of the fixed side holder 23 and the moving side holder 24 for magnetic information to be recorded on each principal surface of the slave disk 40. And the fixed side holder 23 and the moving side holder 24 can bring these master disks 46, 46 in one set of two sheets into close contact with each principal surface of the slave disk 40 so as to sandwich the slave disk 40.

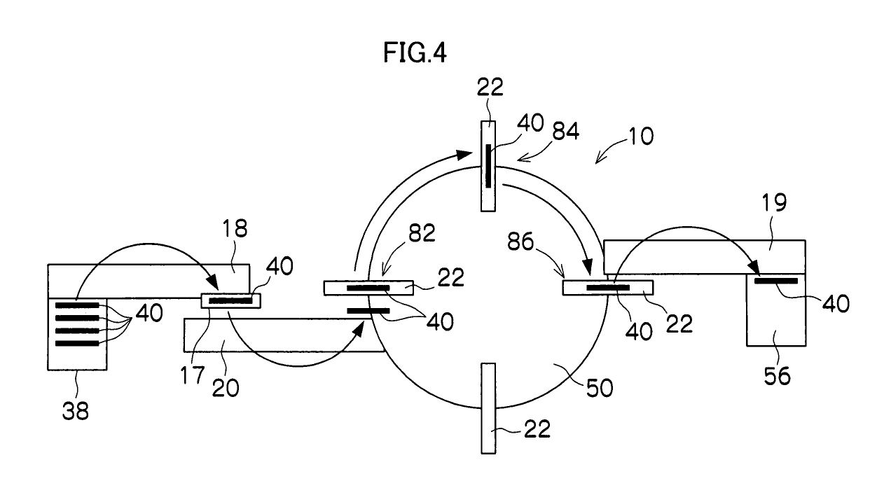

The fixed side holder 23 is a member in the shape of a circular cup and the master disk 46 can be fixed within the cup. The moving side holder 24 is a disk-shaped member and the master disk 46 can be fixed to the surface of the member. Shaft members 23B, 24B are each provided in the center of the back surfaces (on the side opposite to the surfaces to which the master disks 46 are fixed) of the fixed side holder 23 and the moving side holder 24. The shaft member 23B is fixed to the apparatus main body 12. On the other hand, the shaft member 24B is fixed to the apparatus main body 12 via a driving device (not shown) and can move so as to approach and leave the fixed side holder 23. Furthermore, O-rings 25 are fixed in the vicinity of peripheral edges of the fixed side holder 23. Owing to this construction of the holder unit 22, as shown in FIG. 4A, the fixed side holder 23 and the moving side holder 24 are set in positions spaced from each other by a specified distance in supplying and removing the slave disk 40, and brought into a condition which facilitates the handling of the slave disk 40 by a disk supply line 26 and a disk discharge line 34, which will be described later.

On the other hand, in performing the transfer of the slave disk 40 and in actuating a hermetically sealing device by use of an interlock device, which will be described later, and causing a hermetically sealed space to be formed in the interior of the holder unit 22, as shown in FIG. 3B, the fixed side holder 23 and the moving side holder 24 come into contact with each other via the O-rings 25, with the result that a hermetically sealed space is formed in the interior of the holder unit 22. As a result of this, sufficient cleanness can be ensured in the interior of the holder unit 22 and the life of the master disk 46 can be dramatically improved.

Incidentally, the hermetically sealing device is constituted by a driving device connected to the shaft member 24B, the O-ring 25, etc.

As shown in FIG. 3B, the holder unit 22 is constructed in such a manner that in the interior of the holder unit 22, a prescribed clearance is formed between the master disks 46, 46 and the contact of the master disks 46, 46 with each other is thereby prevented. Also when the slave disk 40 is supplied, though not illustrated, the condition of the holder unit 22 is almost the same as the condition shown in FIG. 3B.

In the apparatus main body 12 of FIG. 1, the index table 50 is rotationally driven in an intermittent manner by a driving motor, which is not shown, and each of the holder units 22 is sequentially fed to each step position so as to correspond to each index position and stops there so that multiple works can be performed in parallel with each other. The index table 50 is caused to act intermittently so that the four holder units 22 are constantly arranged in prescribed four positions. That is, each of the holder units 22 stops for each movement at 90 degrees.

Furthermore, the apparatus main body 12 of FIG. 1 is provided with the disk supply line 26 on the side of one side portion of the top surface of the base 60 (in FIG. 1, the left side from the front surface) and with the disk discharge line 34 on the side of the other side portion of the top surface of the base 60 (in FIG. 1, the right side from the front surface).

The disk supply line 26 is a disk supply device capable of directly conveying a slave disk 40 from the disk supply cassette 38 to the holder unit 22 to which the master disks 46, 46 have been attached without delivering the slave disk 40 midway to another check mechanism.

The disk discharge line 34 is a disk discharge device capable of directly conveying a slave disk 40 for which magnetic transfer work has been completed to the disk discharge cassette 56 without delivering the slave disk 40 midway to another check mechanism.

A slave disk 40 taken out of the disk supply cassette 38 is relatively positioned by chucks 42a, 42b (refer to FIG. 2) of the disk supply line 26, which will be described later, with respect to the master disk 46 which has been mounted beforehand in the fixed side holder 23 of the holder unit 22, this slave disk 40 is adsorbed by the holder unit 22 via a space provided in the master disk 46 and delivered to the holder unit 22, and a magnetic information recording surface of the master disk 46 and a magnetic information transfer surface of the slave disk 40 are brought into close contact with each other, the slave disk 40 being held. On the inner side of the fixed side holder 23, an adsorption groove (not shown) which adsorbs a part near the inside diameter of the slave disk 40 is provided and the slave disk 40 is adsorbed and held by this adsorption groove.

As shown in FIG. 2, the disk supply line 26 is constituted by a chuck mechanism 42, which is constituted by the chucks 42a, 42b which are two holding jigs to grip the inside diameter of a slave disk 40 housed in the disk supply cassette 38, XYZ robots 27, 28, 28 as shown in FIG. 1, and a rotary cylinder 44 having a rotary shaft in the Y-axis direction which rotates the chucks 42a, 42b so as to rotate a slave disk 40 through 180 degrees in the X-Z plane. That is, the disk supply line 26 rotates through 180 degrees the chucks 42a, 42b which grip the inside diameter of the slave disk 40 by use of the rotary cylinder 44, reverses the direction of the slave disk 40 and the chuck 42, and conveys the slave disk 40 to the holder unit 22 to deliver the slave disk 40. After the completion of the delivery, the disk supply line 26 returns again to the position of the disk supply cassette 38 and conveys the next slave disk 40 to the holder unit 22.

Although this disk supply line 26 may be constituted by one supply robot constituted by XYZ robots 27, 28, 29 as shown in FIG. 1, two supply robots 18, 20 may also be provided in series, the supply robot 18 being a first supply robot constituted by XYZ robots 27, 28, 29 and the supply robot 20 being a second supply robot 20 constituted by XYZ robots 27, 28, 29, and a relay cassette 17 to relay a slave disk 40 being provided between the two supply robots 18, 20, as shown in FIG. 4. As a result of this, because the first supply robot 18 can convey the next slave disk 40 from the disk supply cassette 38 to the relay cassette 17 while the second supply robot 20 is supplying a slave disk 40 to the holder unit 22, the conveyance efficiency can be improved compared to the case where one supply robot is used.

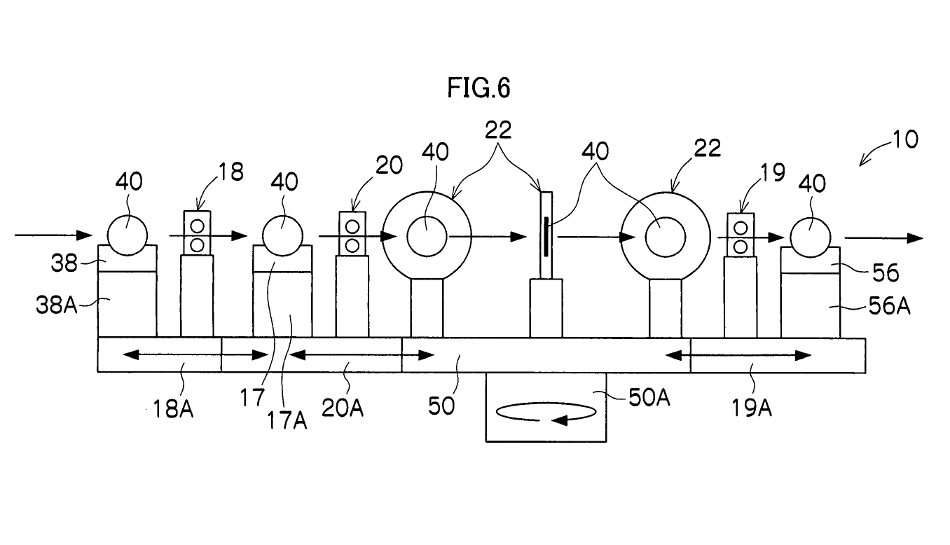

Incidentally, in FIG. 4, the disk supply line 26 and the disk discharge line 34 are positioned on the opposite side, with the magnetic transfer line interposed between the two. However, as shown in FIG. 1, the disk supply line 26 and the disk discharge line 34 may be disposed on the same side (at the front side of the apparatus). The same thing applies also to the cases of FIGS. 6, 7 and 9.

The disk supply line 26 has a mechanism which permits selection between normal conveyance, in which a slave disk 40 is conveyed from the upstream side of the disk supply line 26 to the downstream side thereof (in the direction of the holder unit 22), and reverse conveyance, in which a slave disk 40 is conveyed to the upstream side, by use of a control device 31 (refer to FIG. 1) which controls the operation of the magnetic transfer apparatus 10.

The disk discharge line 34 is a disk takeout device which receives and houses a slave disk 40 after magnetic transfer and directly conveys the slave disk 40 to the disk discharge cassette 56 after the opening of the holder unit 22. The disk discharge line 34 is constituted by a chuck mechanism 52, which is constituted by the chucks 52a, 52b which are two holding jigs to grip the inside diameter of a slave disk 40 (refer to FIG. 2), one discharge robot 19 constituted by XYZ robots 35, 36, 37 as shown in FIG. 1, and a rotary cylinder 54 having a rotary shaft in the X-axis direction which rotates the chucks 52a, 52b so as to rotate a slave disk 40 through 180 degrees in the Y-Z plane. That is, the disk discharge line 34 rotates through 180 degrees the chucks 52a, 52b which grip the inside diameter of the slave disk 40 by use of the rotary cylinder 54, and reverses the direction of the slave disk 40 and the chuck 52.

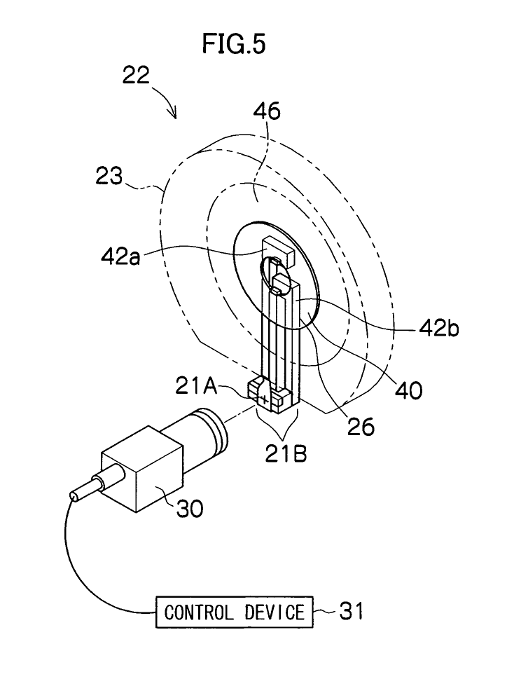

As shown in FIG. 5, a reference mark 21A is attached beforehand to a lower surface portion of the fixed side holder 23 of the holder unit 22, and recognition marks 21B, 21b are attached beforehand to the chucks 42a, 42b of the disk supply line 26. The reference mark 21 and the recognition marks 21B, 21B are visually recognized by a recognition unit 30.

This recognition mark 30 is disposed on the top surface of the base 60 in a position near a side surface opposite to the side surface on which the disk supply cassette 38 is provided. In positioning a slave disk 40 conveyed by the disk supply line 26 to the master disk 46, the recognition unit 30 visually recognizes the reference mark 21 and recognition marks 21B, 21B which have been attached beforehand, respectively, to the holder unit 22 and the disk supply line 26 by use of a CCD camera etc.

The control device 31 is connected to the recognition unit 30, and the recognition unit 30 calculates the center of the master disk 46 from the reference mark 21A which has been recognized and also calculates the center of the slave disk 40 from the recognition marks 21B, 21B which have been recognized. And the recognition device 31 controls the driving of the YZ-axis robots 28, 29 of the disk supply line 26 so that the center of the master disk 46 coincides with the center of the slave disk 40.

The positioned slave disk 40 is moved by an X-axis robot 27 of the disk supply line 26 to a position where the slave disk 40 is brought into contact with the master disk 46 held on the inner side of the fixed side holder 23, and the slave disk 40 is adsorbed to the inner side of the fixed side holder 23 and held. At this time, the positional relationship between the reference mark 21A provided in the fixed side holder 23 and the center position of the master disk 46 held by the fixed side holder 23 has been taught beforehand to the control device 31.

On the basis of the taught positional relationship, the positional relationship between the slave disk 40 and the master disk 46 is indirectly calculated.

On the other hand, for the relationship between the recognition marks 21B, 21B provided in the disk supply line 26 and the center position of the slave disk 40, when it is judged that the center of the slave disk 40 is present on a straight line which connects positions against which the chucks 42a, 42b abut by the chucking action of the chuck mechanism 42, the relationship between the center position and the recognition marks 21B, 21B is taught beforehand to the control device 31. And on the basis of the taught positional relationship, the positional relationship between the slave disk 40 and the master disk 46 is calculated.

Coil units 32, 32 provided in the magnetic transfer line 16 shown in FIG. 1 are such that coils are spaced to both sides as viewed from the stacking direction of the master disks 46, 46 and the slave disk 40, with the holder unit 22 closed and the slave disk 40 held by being sandwiched by the master disks 46, 46 which are respectively fixed to the fixed side holder 23 and moving side holder 24 of the holder unit 22. The coil units 32, 32 apply a magnetic field of prescribed strength to the master disks 46, 46 and the slave disk 40 in order to promote the magnetic transfer action.

It is preferred that the drive part of the magnetic transfer apparatus 10 constructed as described above be disposed below a conveyance height at which a slave disk is conveyed as shown in FIG. 6. In FIG. 6, reference numeral 38A designates 17A a rack of for the supply cassette 38, reference numeral 17A designates a rack for the relay cassette 17, reference numeral 56A designates a rack for the discharge cassette 56, reference numeral 18A designates a drive part of the first supply robot 18, reference numeral 20A designates a drive part of the second supply robot 20, reference numeral 19A designates a drive part of the discharge robot 19, and reference numeral 50A denotes a drive part of the index table 50. Because in this manner the drive parts of the magnetic transfer apparatus 10 are disposed below a conveyance height at which the slave disk 40 is conveyed, owing to the downflow of clean air blown out of the clean unit 14, dusts and the like generated from the drive parts fall down and discharged to outside the apparatus. Therefore, the slave disk 40 becomes less apt to be polluted.

Next, the clean unit 14, which is the characteristic part of the present invention, and ancillary structures of this clean unit 14 will be described below. FIG. 10 is a perspective view which shows the outer shape of the clean unit 14. Incidentally, the illustration of the apparatus main body 12, which has already been described, is omitted in FIG. 10.

The clean unit 14 is provided with an opening portion 14A at the front of the upper half in which the principal part of the apparatus main body 12 is disposed, and this opening portion 14A can be opened with opening doors 14B, 14B, which form a double-leafed hinged door. The other three surfaces of the upper half of the clean unit 14 are constructed by transparent walls in a hermetically sealed condition.

In a ceiling portion of the clean unit 14, there is provided in the middle of the fore-and-aft direction, the clean air blowing unit 116 which supplies clean air to the interior of the apparatus. This clean air blowing unit 116 is constituted by an air filter, such as a HEPA filter and an ULPA filter, and a blowing fan so that clean air having a cleanness class of not more than 3 by downflow can be supplied to the interior of the apparatus.

Air curtain devices 117, 118 are provided in the front and back parts of the ceiling portion of the clean unit 14, with the clean air blowing unit 116 interposed. The air curtain devices 117, 118, which are each constituted by an air filter, such as a HEPA filter and an ULPH filter, and a blowing fan, blow clean air at a flow velocity faster than that of the air blown from the clean air blowing unit 116 and form air curtains at the front of the opening 14A of the clean unit 14 and on the back side of the clean unit 14.

Clean air blown from the clean air blowing unit 116 and the air curtain devices 117, 118 is discharged to outside. For this reason, as shown in FIG. 1, on the base 60, there are disposed multiple exhaust fans 64 as exhaust devices in open areas where each mechanism of the apparatus main proper 12 is not arranged.

A top end portion and a bottom end portion of the leading end side of each of the opening doors 14B, 14B are each provided with a cover lock mechanism 119 (in four places in all). This cover lock mechanism 119 is a lock mechanism which fixes the closed condition of the opening doors 14B, 14B and is a mechanism which cancels the closed condition of the opening doors 14B, 14B by operating a cancel switch 94A or a forced cancel switch 94B, which will be described later.

Each cover lock mechanism 119 is provided with an opening and closing detection sensor, which is not shown, so that the open and closed conditions of the opening doors 14B, 14B can be detected by use of this opening and closing detection sensor.

Near the leading end sides of the opening doors 14B, 14B, handles 120, 120 are provided in the middle of the fore-and-aft direction. The handles 120, 120 are used to manually open the opening doors 14B, 14B (a double-leafed hinged door) when the closed condition of the opening doors 14B, 14B has been canceled.

Below the opening door 14B, a switch box 94 is provided near the right end portion of the front surface of the clean unit 14, and this switch box 94 is provided with the cancel switch 94A and the forced cancel switch 94B.

Both of the cancel switch 94A and the forced cancel switch 94B are connected to a control device (not shown) of the apparatus main body 12 and each of the cancel switch 94A and the forced cancel switch 94B performs the following prescribed actions when manually operated.

That is, when depressed, the cancel switch 94A starts the interlock device and actuates the hermetically sealing devices (the driving device connected to the shaft member 24B, the O-ring 25, etc.) to cause a hermetically sealed space to be formed in the interior of the holder unit 22, and the cancel switch 94A also actuates the air curtain devices 117, 118 to cause air curtains to be formed at the front of the opening 14A of the clean unit 14 and on the back side of the clean unit 14, and then cancels the closed condition of the opening doors 14B, 14B by actuating the cover lock mechanisms 119, 119.

On the other hand, when depressed, the forced cancel switch 94B, actuates the cover lock mechanisms 119, 119, . . . regardless of the condition of the holder unit 22 and cancels the closed condition of the opening doors 14B, 14B. That is, the forced cancel switch 94B is a device which releases the interlock device in a forced manner.

Incidentally, in order to ensure that when the forced cancel switch 94B is depressed, selection can be made between a condition in which the air curtain devices 117, 118 are actuated and a condition in which the air curtain devices 117, 118 are not actuated, a selection device (switch) for this purpose is provided on an operation panel (not shown).

A patrol light 90 is provided on the top surface of the right-hand rear portion of the clean unit 14 shown in FIG. 1. This patrol light 90 serves as a judgment device which makes it known to workers whether the hermetically sealing device has been actuated and simultaneously as an alarm device which makes it known to workers that the hermetically sealing device is not actuated.

If it can be easily discerned whether the hermetically sealing devices (the driving devices connected to the shaft member 24B shown in FIGS. 3A and 3B, the O-ring, etc.) have been actuated, it becomes easy for workers to prevent wrong actions. If an alarm is given when there is a high possibility that the master disks 46, 46 are polluted, this is convenient for workers.

A distinction between the judgment device and the alarm device can be easily made by using different display colors for the patrol lights 90 and using an alarm sound in combination.

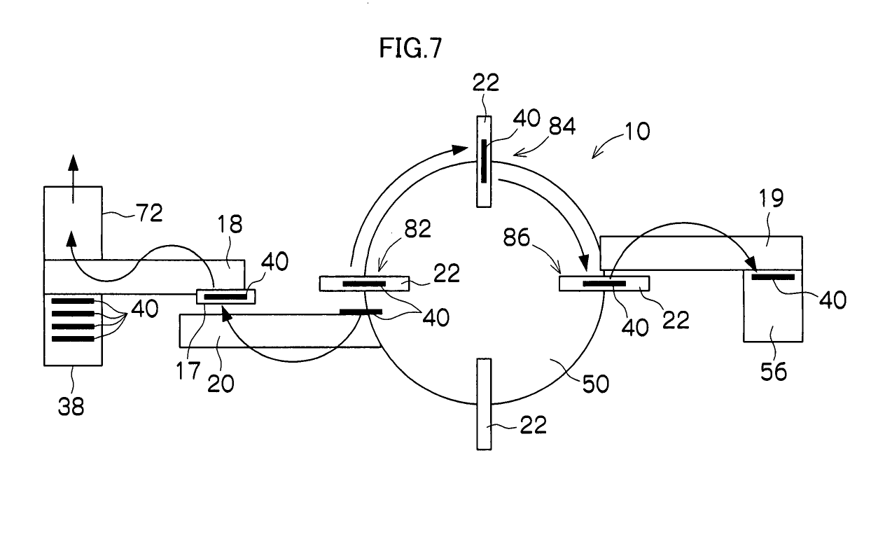

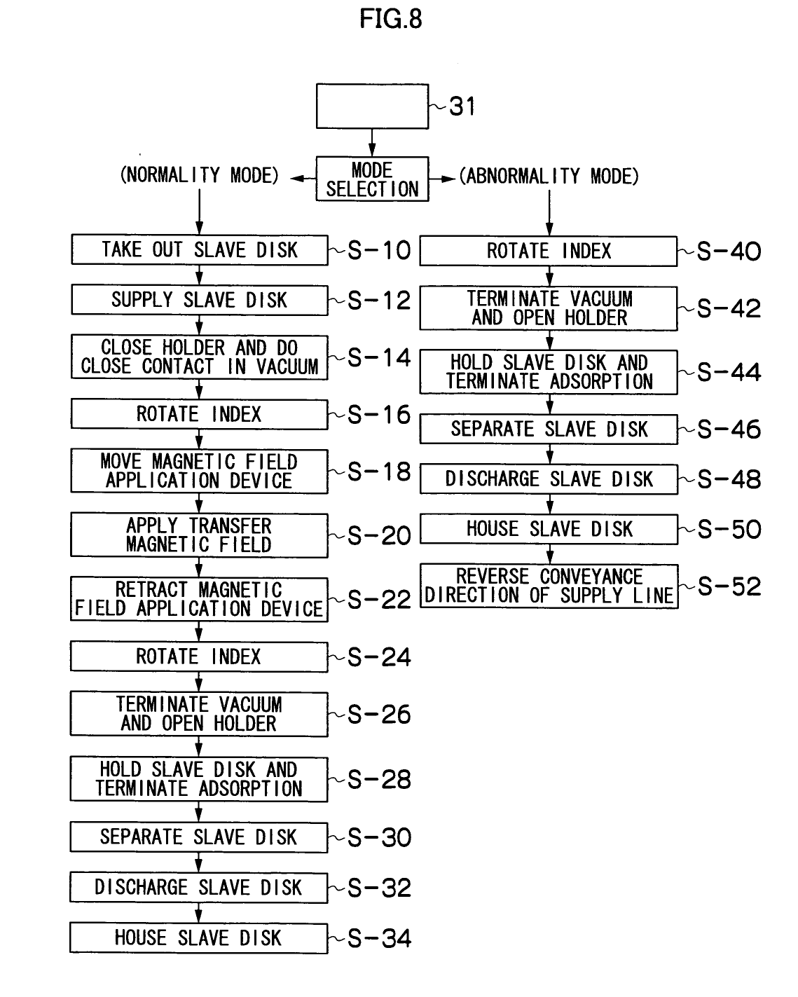

Next, a method of operating the magnetic transfer apparatus 10 of the first embodiment constructed as described above will be described. FIG. 7 is a conceptual diagram to explain the flow of a slave disk 40 in an operating method of the present invention and FIG. 8 is a flowchart of a control program to explain an operating method of the present invention. Incidentally, the disk supply line 26 is described in a case where the relay cassette 17 is provided between two robots 18, 20 to ensure that the present invention is easily understandable. The flow of the conveyance of a slave disk 40 by a conventional operation is described by using FIG. 4.

When a power source of the magnetic transfer apparatus 10 is put to work, the control device 31 automatically selects a normality mode in mode selection and executes the program on the left side of FIG. 8. That is, at the start of operation, the chuck mechanism 42 (chucks 42a, 42b) of the disk supply line 26 grips a slave disk 40 within the supply cassette 38 and takes out slave disks one by one (Step S-10).

The slave disk 40 which has been taken out is conveyed by the first supply robot 18 to the relay cassette 17 and is temporarily placed in the relay cassette 17. The slave disk 40 which has been placed in the relay cassette 17 is then taken out by the second supply robot 20, moved to above a direction orthogonal to the opening and closing direction of the holder unit 22 in a space between the master disks 46, 46, which is formed by the opened holder unit 22 disposed in a disk supply step potion 82, and inserted into a gap between the master disks 46, 46 (Step S-12).

At this time, on the inner side of each of the fixed side holder 23 and moving side holder 24 of the holder unit 22, the master disks 46, 46 have each been fixed beforehand with good accuracy by adsorption or adhesion as off-line setups etc. in positions which ensure that the center of the holder unit 22 and the center of the master disk 46 coincide with each other.

The slave disk 40 which has been supplied between the fixed side holder 23 and moving side holder 24 of the holder unit 22 is moved to a recognition position where the center of the slave disk 40 coincides substantially with the center of the master disk 46 which is fixed to the inner side of the fixed side holder 23 by the second supply robot 20 of the disk supply line 26 and the gap from the master disk 46 is about 0.5 mm.

Subsequently, the recognition unit 30 recognizes the reference mark 21A which has been attached beforehand to the lower surface of the fixed side holder 23 and the recognition marks 21B, 21B which have been attached beforehand to the chuck mechanism 42 (chucks 42a, 42b) of the disk supply line 26.

On the basis of this recognition, the slave disk 40 is positioned by the YZ-axis robots 28, 29 of the second supply robot 20 so that the center of the master disk 46 calculated from the reference mark 21A and the center of the slave disk 40 calculated from the recognition marks 21B, 21B of the chuck mechanism 42 coincide with each other.

Subsequently, the slave disk 40 is moved by the X-axis robot 27 of the second supply robot 20 to a position where the slave disk 40 comes into close contact with the master disk 46 fixed to the inner side of the fixed side holder 23, and adsorbed and fixed to the inner side of the fixed side holder 23.

Subsequently, the moving side holder 24 is moved by the robot 70 toward the fixed side holder 23 and both surfaces of the slave disk 40 are sandwiched between the two master disks 46, 46. In this manner, both surfaces of the slave disk 40 are sandwiched, with both surfaces in close contact with the two master disks 46, 46 (Step S-14).

Subsequently, by rotating the index table 50 through 90 degrees (Step S-16), the holder unit 22 is positioned in a magnetic transfer step position 84 of the next step. And the coil units 32, 32 are moved to both sides of the holder unit 22 (Step S-18) and a magnetic field is applied from both sides while the holder unit 22 is being rotated (Step S-20). As a result of this, magnetic information patterns of the master disks 46, 46 are magnetically transferred to both surfaces of the slave disk 40.

After the magnetic transfer, the coil units 32, 32 are retracted to the initial positions (Step S-22), and by rotating the index table 50 through 90 degrees, the holder unit 22 is positioned in a disk-discharge step position 86 of the next step (Step S-24).

Subsequently, the moving side holder 24 is moved and spaced from the fixed side holder 23, and the holder unit 22 is opened (Step S-26). At this time, the slave disk 40 for which magnetic transfer has been performed is adsorbed to the inner side of the fixed side holder 23 in the same manner as during supply.

In the next step (Step S-28), the chuck 52 of the disk discharge line 34 enters the space between the fixed side holder 23 and the moving side holder 24, grips the inside diameter of the slave disk 40, and terminates the adsorption of the slave disk 40 by the fixed side holder 23.

In the next step (Step S-30), by moving the chuck 52 of the disk discharge line 34 by use of the X-axis robot 35 of the discharge robot 19, the slave disk 40 is separated from the master disk 46 of the fixed side holder 23.

Subsequently, while being kept gripped by the chuck 52 of the disk discharge line 34, the slave disk 40 is retracted in the Y-axis direction from the open space of the holder unit 22 by the Y-axis robot 36 of the discharge robot 19. And the slave disk 40 is rotated through 180 degrees by the rotary cylinder 54 in the YZ plane and in a circular arc path passing outward the apparatus and the vertical direction of the slave disk 40 including the chuck 52 is reversed (Step S-32).

Subsequently, the slave disk 40 and the chuck 56 are moved onto the disk discharge cassette 56 by the XYZ robots 35, 36, 37 of the discharge robot 19 and sequentially housed one by one into the disk discharge cassette 56 (Step S-34).

In the above-described series of actions, by positioning the holder unit 22 in each step position while intermittently rotating the index table 50 in sequence, it is possible to treat each step parallel to each other.

When an abnormality occurs in the magnetic transfer apparatus 10 during the above-described series of normality mode operations, the control device 31 changes over the program from the normality mode to the abnormality mode. The occurrence of an abnormality in the magnetic transfer apparatus 10 refers to, for example, a decrease in the cleanness within the apparatus, poor magnetic transfer due to an abnormality in the coil unit 32, poor positioning of the slave disk 40 and the master disk 46 and the like. However, abnormalities are not limited to them and refer to all abnormalities that impair normal magnetic transfer.

By changing over the program from the normality mode to the abnormality mode, the driving of the coil units 32, 32 is stopped in the magnetic transfer line 16, but all other drive parts are driven in the same manner as in the normality mode. That is, as indicated by arrows in the flow of FIG. 7 until the discharge of the slave disk 40, by rotating the index table 50 through 90 degrees, the holder unit 22 is positioned in the disk-discharge step position 86 of the next step (Step S-40). Subsequently, the moving side holder 24 is moved and spaced from the fixed side holder 23, and the holder unit 22 is opened (Step S-42). At this time, the slave disk 40 for which magnetic transfer has been performed is adsorbed to the inner side of the fixed side holder 23 in the same manner as during supply.

In the next step (Step S-44), the chuck 52 of the disk discharge line 34 enters the clearance between the fixed side holder 23 and the moving side holder 24, grips the inside diameter of the slave disk 40 and cancels the adsorption of the slave disk 40 by the fixed side holder 23.

In the next step (Step S-46), by moving the chuck 52 of the disk discharge line 34 by use of the X-axis robot 35 of the discharge robot 19, the slave disk 40 is separated from the master disk 46 of the fixed side holder 23. Subsequently, while being kept gripped by the chuck 52 of the disk discharge line 34, the slave disk 40 is retracted in the Y-axis direction from the open space of the holder unit 22 by the Y-axis robot 36 of the discharge robot 19. And the slave disk 40 is rotated through 180 degrees by the rotary cylinder 54 in the YZ plane and in a circular arc path passing outward the apparatus and the vertical direction of the slave disk 40 including the chuck 52 is reversed (Step S-48). Subsequently, the slave disk 40 and the chuck 56 are moved onto the disk discharge cassette 56 by the XYZ robots 35, 36, 37 of the discharge robot 19 and the slave disk 40 is sequentially housed one by one into the disk discharge cassette 56 (Step S-50).

As a result of this, the slave disk 40 present in or behind the magnetic transfer line 16 is conveyed to the downstream side and discharged to outside the apparatus 10 via the disk discharge line 34.

In the next step (Step 52), the driving of the disk supply line 26 is changed over from normal conveyance to reverse conveyance. As a result of this, the slave disk 40 present in the disk supply line 26 is returned to the upstream side by the reverse conveyance control of the disk supply line 26 and discharged to outside the apparatus 10. In this case, as shown in FIG. 7, it is preferred that the slave disk 40 which has been returned to the upstream side be discharged to outside the apparatus 10 via a discharge outlet intended for use only during an abnormality 72, and be not returned to the disk supply cassette 38. As a result of this, by discharging a slave disk 40 present in the disk supply line 26 during the occurrence of an abnormality to outside the apparatus 10 from the discharge outlet intended for use only during an abnormality 72, it is possible to clearly discern that this slave disk is a slave disk 40 during an abnormality. Although Step 52 is carried out after Step 40, it is also possible to carry Step 40 to Step 50 and Step 52 parallel o each other.

In contrast to this, in the conventional flow until the conveyance of the slave disk 40 during the occurrence of an abnormality shown in FIG. 4, all slave disks 40 remaining within the apparatus 10 are discharged to outside the apparatus 10 by being caused to flow to the discharge side. Therefore, in the process of discharge, even slave disks 40 present in the disk supply line 26 before magnetic transfer must be brought into close contact with the master disk 46 and the risk of polluting the master disk 46 increases.

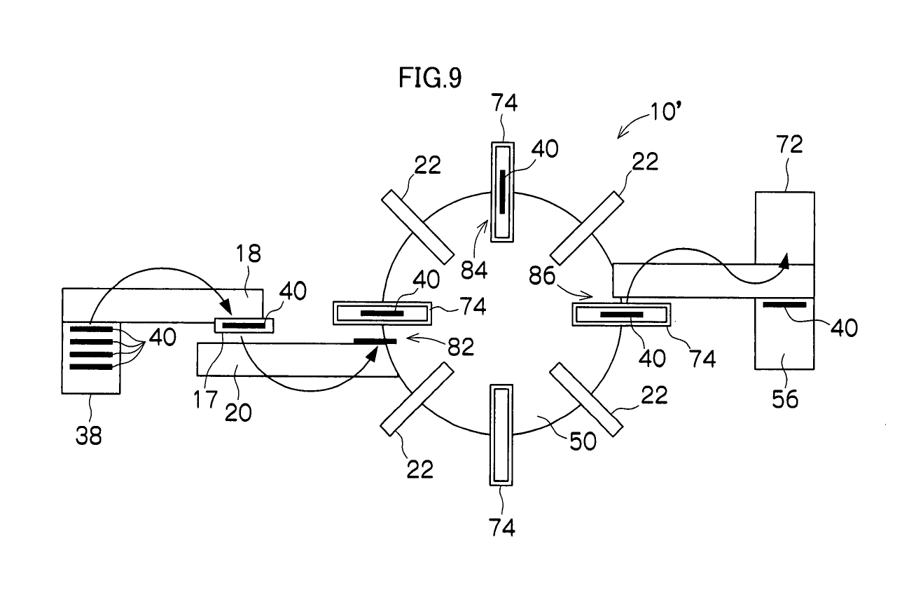

Next, a magnetic transfer apparatus 10′ in the second embodiment of the present invention will be described by using a conceptual diagram of FIG. 9.

The general construction of the magnetic transfer apparatus 10′ in the second embodiment of the present invention is the same as that of the magnetic transfer apparatus 10 shown in FIG. 1. As is apparent from FIG. 9, however, a total of four abnormality holder units 74 are provided between four holder units 22. The abnormality holder units 74 are rotated by the rotation of the index table 50 and receive slave disks 40 present in the disk supply line 26 in place of the holder units 22 during an abnormality in the magnetic transfer apparatus 10′. That is, in the circumferential direction of the index table 50, the holder units 22 and the abnormality holder 74 are alternately provided at every 45 degrees. The construction of the abnormality holder unit 74 is basically the same as the construction of the holder unit 22 shown in FIGS. 3A and 3B. However, it is unnecessary that the master disks 46 be fixed to the fixed side holder 23 and the moving side holder unit 24, which are a pair of holder portions of the abnormality holder unit 74, and it is necessary only that a disk for holding the slave disk 40 be fixed. The construction of the abnormality holder unit 74 is not limited by the construction of the holder unit 22 so long as the construction of the abnormality holder unit 74 permits the delivery of a slave disk 40 in the disk supply line 26 to the disk discharge line 34 without generating flaws etc. in the slave disk 40.

When an abnormality occurs in the magnetic transfer apparatus 10′ of the second embodiment, the control device 31 rotates the index table 50 through 45 degrees only for the first rotation and stops the abnormality holder unit 74 in a disk-supply step position 82, and the index table 50 rotates each through 90 degrees from the next rotation. As a result of this, as shown in FIG. 9, slave disks 40 present in the disk supply line 26 are delivered one by one to the abnormality holder unit 74 in place of the holder unit 22, conveyed to a disk-discharge step position 86 by the rotation of the index table 50, and housed in the disk discharge cassette 56 via the disk discharge line 34. Also in this case, it is preferred that the discharge outlet intended for use only during an abnormality 72 be provided and that slave disks be discharged from the discharge outlet intended for use only during an abnormality 72 to outside the apparatus 10′.

The third embodiment of a magnetic transfer apparatus related to the present invention will be described below. Incidentally, the same members as in the first and second embodiments are given the same reference numerals and their descriptions are omitted.

The construction of the magnetic transfer apparatus related to the third embodiment of the present invention and an operation method thereof in a steady state are the same as in the magnetic transfer apparatus 10 related to the first embodiment. However, there are cases where during a steady-state operation, the emergency stop of the operation is performed due to troubles such as breakdowns in the apparatus and the occurrence of an abnormal situation. Adjustment work during preparations for operation is also frequently performed. On that occasion, it is necessary to open the opening doors 14B, 14B of the clean unit 14. This work will be described below.

In a case where the master disks 46, 46 are housed in the interior of the holder unit 22 and it is necessary to prevent pollution in opening the opening doors 14B, 14B of the clean unit 14, the cancel switch 94A is depressed.

As a result of this, the cancel switch 94A starts the interlock device and actuates the hermetically sealing devices (the driving device connected to the shaft member 24B, the O-ring 25, etc.) to cause a hermetically sealed space to be formed in the interior of the holder unit 22, and the cancel switch 94A also actuates the air curtain devices 117, 118 to cause air curtains to be formed at the front of the opening 14A of the clean unit 14 and on the back side of the clean unit 14, and then cancels the closed condition of the opening doors 14B, 14B by actuating the cover lock mechanisms 119, 119.

On the other hand, when depressed, the forced cancel switch 94B, actuates the cover lock mechanisms 119, 119, . . . regardless of the condition of the holder unit 22 and cancels the closed condition of the opening doors 14B, 14B. That is, the forced cancel switch 94B is a device which releases the interlock device in a forced manner.

Incidentally, in order to ensure that when the forced cancel switch 94B is depressed, selection can be made between a condition in which the air curtain devices 117, 118 are actuated and a condition in which the air curtain devices 117, 118 are not actuated, a selection device (switch) for this purpose is provided on an operation panel (not shown).

Also, as shown in FIG. 1, a patrol light 90 is provided on the top surface of the right-hand rear portion of the clean unit 14. This patrol light 90 serves as a judgment device which makes it known to workers whether the hermetically sealing device has been actuated and simultaneously as an alarm device which makes it known to workers that the hermetically sealing device is not actuated.

If it can be easily discerned whether the hermetically sealing devices (the driving devices connected to the shaft member 24B shown in FIGS. 3A and 3B, the O-ring 25, etc.) have been actuated, it becomes easy for workers to prevent wrong actions. If an alarm is given when there is a high possibility that the master disks 46, 46 are polluted, this is convenient for workers.

A distinction between the judgment device and the alarm device can be easily made by using different display colors for the patrol lights 90 and using an alarm sound in combination.

As described above, the magnetic transfer apparatus related to the third embodiment is provided with a hermetically sealing device which causes a hermetically sealed space to be formed in the interior of the holder unit 22 and an interlock device which actuates the hermetically sealing device before the interior of the clean unit 14 is exposed to a normal atmosphere by opening the opening doors 14B, 14B and thereby causes a hermetically sealed space to be formed in the interior of the holder unit 22. Therefore, sufficient cleanness can be ensured in the interior of the holder unit 22 during troubles such as breakdowns of the apparatus and even when adjustment work is necessary and the life of the master disks 46, 46 can be dramatically improved.

Embodiments of the magnetic transfer apparatus related to the present invention have so far been described above. However, the present invention is not limited to the above-described embodiments and various embodiments can be adopted.

For example, in the above-described embodiments, the construction is such that the cleanness in the peripheral portion of the holder unit 22 is ensured by the clean air blowing unit 116 and the air curtain devices 117, 118 provided before and behind this clean air blowing unit. However, in place of this construction or along with this construction, it is also possible to adopt a construction in which the blast volume (flow rate of the clean air) from the clean air blowing unit 116 is increased before the interior of the clean unit 14 is exposed to a normal atmosphere, and an almost similar effect is obtained.

The construction etc. of the holder unit 22 is not limited to the above-described embodiments, and various embodiments can be adopted.

What is claimed is:

1. A method of operating a magnetic transfer apparatus for magnetically transferring a specific magnetic information pattern formed in a master disk to a slave disk,
wherein during the occurrence of an abnormality in the magnetic transfer apparatus, the slave disk present within the magnetic transfer apparatus is automatically discharged to outside the apparatus without being brought into contact with the master disk.

2. A method of operating a magnetic transfer apparatus including a disk supply line which supplies a slave disk to a holder portion which holds a master disk having a specific magnetic information pattern, a magnetic transfer line which transfers the magnetic information pattern of the master disk by applying a transfer magnetic field after bringing the slave disk into close contact with the master disk held in the holder portion, and a disk discharge line which discharges the slave disk after magnetic transfer, which are arranged in sequence from the upstream to downstream side of the apparatus,
wherein during the occurrence of an abnormality in the magnetic transfer apparatus, a slave disk present in or behind the magnetic transfer line is conveyed to the downstream side and discharged to outside the apparatus via the disk discharge line, whereas a slave disk present in the disk supply line is returned to the upstream side by reverse conveyance control of the disk supply line and discharged to outside the apparatus.

3. The method of operating a magnetic transfer apparatus according to claim 2, wherein a slave disk which has been returned to the upstream side via the disk supply line is discharged to outside the apparatus from a discharge outlet intended for use only during an abnormality.

4. A method of operating a magnetic transfer apparatus including a disk supply line which supplies a slave disk to a holder portion which holds a master disk having a specific magnetic information pattern, a magnetic transfer line which transfers the magnetic information pattern of the master disk by applying a transfer magnetic field after bringing the slave disk into close contact with the master disk held in the holder portion, and a disk discharge line which discharges the slave disk after magnetic transfer, which are arranged in sequence from the upstream to downstream side of the apparatus,
wherein during the occurrence of an abnormality in the magnetic transfer apparatus, a slave disk present in or behind the magnetic transfer line is conveyed to the downstream side and discharged to outside the apparatus via the disk discharge line, whereas a slave disk present in the disk supply line is discharged to outside the apparatus via a conveyance device to work during an abnormality which conveys a disk to the disk discharge line without passing through the holder portion.

5. The method of operating a magnetic transfer apparatus according to claim 4, wherein the conveyance device to work during an abnormality is a holder portion intended for use only during an abnormality, which is provided in the magnetic transfer line separately from the holder portion.

6. A magnetic transfer apparatus for magnetically transferring a specific magnetic information pattern formed in a master disk to a slave disk, the magnetic transfer apparatus comprising:
a mechanism which automatically discharges a slave disk present within the magnetic transfer apparatus to outside the apparatus without bringing the slave disk into contact with the master disk.

7. A magnetic transfer apparatus including a disk supply line which supplies a slave disk to a holder portion which holds a master disk having a specific magnetic information pattern, a magnetic transfer line which transfers the magnetic information pattern of the master disk by applying a transfer magnetic field after bringing the slave disk into close contact with the master disk held in the holder portion, and a disk discharge line which discharges the slave disk after magnetic transfer, which are arranged in sequence from the upstream to downstream side of the apparatus, the magnetic transfer apparatus comprising:
a mechanism which can select the conveyance direction of the slave disk in the disk supply line from normal and reverse directions; and
a control device which controls the operation of the magnetic transfer apparatus performs a shift to a control mode to work during an abnormality in which, during the occurrence of an abnormality in the magnetic transfer apparatus, a slave disk present in or behind the disk supply line is conveyed in the normal direction to the downstream side and a slave disk present in the disk supply line is conveyed in the reverse direction to the upstream side.

8. A magnetic transfer apparatus including a disk supply line which supplies a slave disk to a holder portion which holds a master disk having a specific magnetic information pattern, a magnetic transfer line which transfers the magnetic information pattern of the master disk by applying a transfer magnetic field after bringing the slave disk into close contact with the master base held in the holder portion, and a disk discharge line which discharges the slave disk after magnetic transfer, which are arranged in sequence from the upstream to downstream side of the apparatus,
wherein the holder portion is arranged in multiple numbers at prescribed intervals in the circumferential direction, and the apparatus comprises:
an index table which sequentially feeds the holder portion to each operating position corresponding to each index position by intermittent rotations; and
a holder portion intended for use only during an abnormality which is arranged between the multiple holder portions and is intermittently rotated by the rotation of the index table and receives a slave disk present in the disk supply line in place of the holder portion during the occurrence of an abnormality in the magnetic transfer apparatus.

9. The magnetic transfer apparatus according to claim 6, wherein a drive part of the magnetic transfer apparatus is disposed below a conveyance height at which the slave disk is conveyed.

10. The magnetic transfer apparatus according to claim 7, wherein a drive part of the magnetic transfer apparatus is disposed below a conveyance height at which the slave disk is conveyed.

11. The magnetic transfer apparatus according to claim 8, wherein a drive part of the magnetic transfer apparatus is disposed below a conveyance height at which the slave disk is conveyed.

12. A magnetic recording medium manufactured by the method of operating a magnetic transfer apparatus according to claim 1.

13. A magnetic recording medium manufactured by the method of operating a magnetic transfer apparatus according to claim 2.

14. A magnetic recording medium manufactured by the method of operating a magnetic transfer apparatus according to claim 3.

15. A magnetic recording medium manufactured by the method of operating a magnetic transfer apparatus according to claim 4.

16. A magnetic recording medium manufactured by the method of operating a magnetic transfer apparatus according to claim 5.

17. A magnetic transfer apparatus, comprising:
a clean unit having an opening capable of being opened and closed by use of an opening door;
a disk holding device which holds a pair of master disks each having a magnetic pattern by use of a pair of holder portions disposed in the interior of the clean unit;
a supply device which supplies a slave disk between the pair of master disks held by the pair of holder portions in the interior of the clean unit;
a drive device which actuates the holding device and causes the master disks to be pressed against both surfaces of the slave disk;
a magnetic field application device which applies a magnetic field to the pair of holder portions in the interior of the clean unit and causes the magnetic pattern of the pair of master disks to be transferred to both sides of the slave disk;
a hermetically sealing device which brings the pair of holders into close contact with each other and thereby causes a hermetically sealed space to be formed in the interior of the pair of holder portions; and
an interlock device which actuates the hermetically sealing device before the interior of the clean unit is exposed to a normal atmosphere by opening the opening door and thereby causes a hermetically sealed space to be formed in the interior of the pair of holder portions.

18. The magnetic transfer device according to claim 17, wherein holding positions of the master disks in the holder portions are set so that the contact of the master disks with each other is avoided when the hermetically sealing device is actuated.

19. The magnetic transfer apparatus according to claim 17, further comprising:
an air filter provided in an upper part of the clean unit so that clean air having a cleanness class of not more than 3 can be supplied to peripheral edges of the pair of holder portions;
an air curtain device provided in a place which is the upper part of the clean unit and on the inside of the opening; and
an interlock device which actuates the air curtain device before the interior of the clean unit is exposed to a normal atmosphere by opening the opening door and thereby causes an air curtain to be formed on the inside of the opening.

20. The magnetic transfer apparatus according to claim 18, further comprising:
an air filter provided in an upper part of the clean unit so that clean air having a cleanness class of not more than 3 can be supplied to peripheral edges of the pair of holder portions;
an air curtain device provided in a place which is the upper part of the clean unit and on the inside of the opening; and
an interlock device which actuates the air curtain device before the interior of the clean unit is exposed to a normal atmosphere by opening the opening door and thereby causes an air curtain to be formed on the inside of the opening.

21. The magnetic transfer apparatus according to claim 17, further comprising:
an air filter provided in an upper part of the clean unit so that clean air having a cleanness class of not more than 3 can be supplied to peripheral edges of the pair of holder portions and the flow rate of the clean air can be changed by not less than two stages; and
an interlock device which increases the flow rate of the clean air supplied from the air filter before the interior of the clean unit is exposed to a normal atmosphere by opening the opening door.

22. The magnetic transfer apparatus according to claim 18, further comprising:
an air filter provided in an upper part of the clean unit so that clean air having a cleanness class of not more than 3 can be supplied to peripheral edges of the pair of holder portions and the flow rate of the clean air can be changed by not less than two stages; and
an interlock device which increases the flow rate of the clean air supplied from the air filter before the interior of the clean unit is exposed to a normal atmosphere by opening the opening door.

23. The magnetic transfer device according to claim 17, wherein the interlock device can be released in a forced manner.

24. The magnetic transfer device according to claim 18, wherein the interlock device can be released in a forced manner.

25. The magnetic transfer device according to claim 19, wherein the interlock device can be released in a forced manner.

26. The magnetic transfer device according to claim 21, wherein the interlock device can be released in a forced manner.

27. The magnetic transfer device according to claim 17, further comprising a judgment device which makes it known to workers whether the hermetically sealing device has been actuated.

28. The magnetic transfer device according to claim 18, further comprising a judgment device which makes it known to workers whether the hermetically sealing device has been actuated.

29. The magnetic transfer device according to claim 19, further comprising a judgment device which makes it known to workers whether the hermetically sealing device has been actuated.

30. The magnetic transfer device according to claim 21, further comprising a judgment device which makes it known to workers whether the hermetically sealing device has been actuated.

31. The magnetic transfer device according to claim 23, further comprising a judgment device which makes it known to workers whether the hermetically sealing device has been actuated.

32. The magnetic transfer device according to claim 17, further comprising an alarm device which makes it known to workers that the opening door has been opened and that the hermetically sealing device has not been actuated.

33. The magnetic transfer device according to claim 18, further comprising an alarm device which makes it known to workers that the opening door has been opened and that the hermetically sealing device has not been actuated.

34. The magnetic transfer device according to claim 19, further comprising an alarm device which makes it known to workers that the opening door has been opened and that the hermetically sealing device has not been actuated.

35. The magnetic transfer device according to claim 21, further comprising an alarm device which makes it known to workers that the opening door has been opened and that the hermetically sealing device has not been actuated.

36. The magnetic transfer device according to claim 23, further comprising an alarm device which makes it known to workers that the opening door has been opened and that the hermetically sealing device has not been actuated.

37. The magnetic transfer device according to claim 27, further comprising an alarm device which makes it known to workers that the opening door has been opened and that the hermetically sealing device has not been actuated.
